(19) United States
(12) Patent Application Publication
(10) Pub. No.: US 2011/0283936 A1
(43) Pub. Date: Nov. 24, 2011

(54) METHODS FOR MANUFACTURING A PAINT ROLLER AND COMPONENT PARTS THEREOF

(76) Inventor: Chandra SEKAR, Searingtown, NY (US)

(21) Appl. No.: 12/782,416

(22) Filed: May 18, 2010

(51) Int. Cl. B05C 1/00; B32B 38/04; B32B 37/24; B65H 81/00; B32B 37/02

(52) U.S. Cl. 118/262; 156/190; 156/60; 156/244.13; 156/250

(57) ABSTRACT

Described are paint rollers formed using nucleated polypropylene and methods of making a paint roller using one or more thermoplastic components comprising nucleated polypropylene. Described are methods of making a paint roller using preformed strips or core material comprising nucleated polypropylene. The nucleated polypropylene adhesive and/or the nucleated polypropylene strips may further comprise between 5% and 66% calcium carbonate by weight. One or various levels of nucleation and/or compounds including calcium carbonate may be used to form portions of one or multiple components that make up the paint roller, including, for example, the thermoplastic strips, adhesives and/or the backing of a composite cover material. The materials can be assembled in a continuous manufacturing process.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

This invention pertains to methods and apparatus for making paint rollers of the type used for applying paint to walls and the like. More specifically, the invention pertains to methods and apparatus for making component parts for use in a process of making a paint roller, and methods and apparatus for making a paint roller.

### BRIEF DESCRIPTION OF THE DRAWINGS

In the accompanying drawings forming a part of this specification, and in which like reference characters are employed to designate like parts throughout the same:

FIG. 1 is a diagrammatic representation of a paint roller manufacturing apparatus that can be used in accordance with an embodiment of the present invention.

FIG. 2 is a diagrammatic representation of an apparatus for forming a composite paint roller cover having a compound backing in accordance with an embodiment of the present invention.

FIG. 3 is a diagrammatic representation of a multi-strip laminate paint roller manufacturing apparatus that can be used in accordance with an embodiment of the present invention.

FIG. 4 is a diagrammatic representation of another paint roller manufacturing apparatus that can be used in accordance with an embodiment of the present invention.

FIG. 5 is a diagrammatic representation of yet another paint roller manufacturing apparatus that can be used in accordance with an embodiment of the present invention.

### DETAILED DESCRIPTION OF THE INVENTION AND EMBODIMENTS THEREOF

Polypropylene is used in the manufacture of paint rollers due to its low cost and resistance to solvents. The inventor has numerous prior and pending patents directed to continuous processes for making paint rollers using thermoplastic strips and/or thermoplastic adhesives that are formed entirely, substantially, or in part from polypropylene. Mr. Sekar's prior patents include, without limitation, U.S. Pat. Nos. 5,195,242 and 5,572,790, each entitled Method of Making a Paint Roller, and U.S. Pat. No. 6,159,134 entitled Method of Making a Paint Roller With Integrated Core and Cover. Mr. Sekar's pending applications include, without limitation, U.S. patent application Ser. No. 12/350,798 filed Jan. 8, 2009, U.S. patent application Ser. No. 12/435,946 filed May 5, 2009, U.S. patent application Ser. No. 12/463,876 filed May 11, 2009 and U.S. patent application Ser. No. 12/687,028 filed Jan. 13, 2010.

### Nucleating Agents and Polypropylene

Nucleating agents can be used to create nucleated polypropylene. Nucleating agents that can be used with polypropylene to create nucleated polypropylene include talc and carboxylate salts (e.g. sodium benzoate, NaOBz), sorbitol acetals and phosphate ester salts. Nucleated polypropylene is known to have certain properties that differ from non-nucleated polypropylene. For example, a nucleated polypropylene can be purchased from Total Petrochemicals of Houston, Tex. under the trade name TOTAL Polypropylene 4481 WA, which Total Petrochemicals describes in its technical data sheet as follows:
TOTAL Polypropylene 4481WZ polypropylene is a nucleated impact copolymer with a Melt Flow of 4.0 g/10 min.
TOTAL Polypropylene 4481WZ is characterized by a good stiffness/impact balance coupled with high creep resistance. This grade has been developed for sheet extrusion and thermoforming applications requiring good mechanical properties and aesthetic appearance.
TOTAL Polypropylene 4481WZ has been specially formulated with an additive for excellent antistatic properties as well as good surface appearance and mold release.

Moreover, while typical polypropylene generally has a heat deflection temperature of around 90-95 degrees centigrade, the technical data sheet for TOTAL Polypropylene 4481WZ identifies its heat deflection temperature as 115 degrees centigrade.

Another nucleated polypropylene can be purchased from Pinnacle Polymers of Garyville, La. under the trade name 2180H, which Pinnacle Polymers describes in its technical data sheet as an 80 melt flow (g/10 min.) medium impact copolymer polypropylene for injection molding. Pinnacle Polymers states that 2180H contains nucleator and antistat. Pinnacle Polymers states in its technical data sheet that the 2180H product provides:
High stiffness
Excellent impact at 23° C. and −30° C.
Very high melt flow
Excellent mold release
Superior processability
Excellent lot-to-lot consistency

### Examples of Machines that can be Used in Manufacturing Paint Rollers

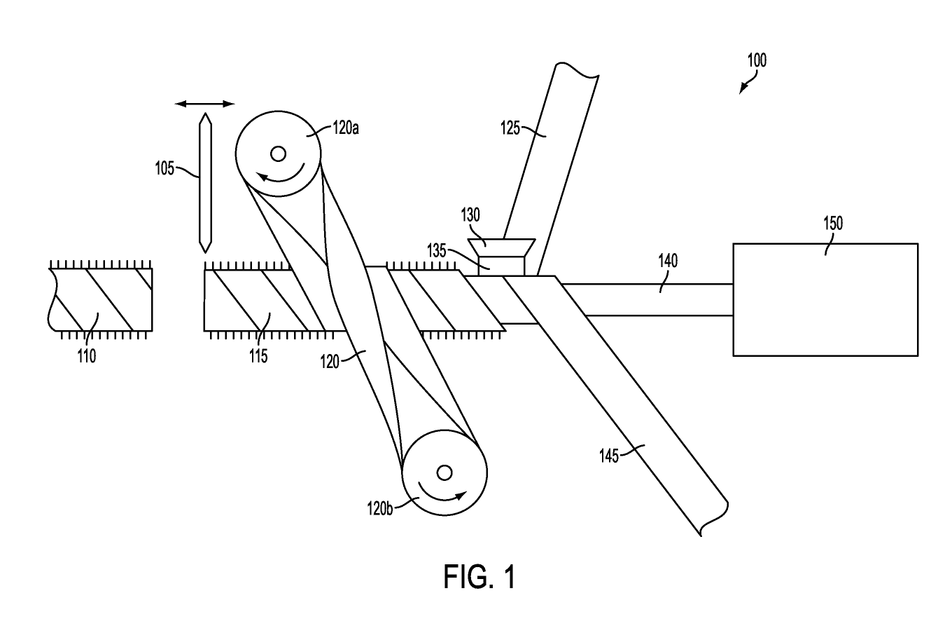

FIG. 1 shows a diagrammatic representation of a paint roller manufacturing apparatus 100. A strip of material 145 generally comprising polypropylene is wrapped helically about a mandrel 140 held on a base 150. The mandrel may be cooled by a cooler (not shown). An adhesive 135 generally comprising polypropylene is applied to an outer surface of the strip 145 by applicator 130. A cover 125 is wrapped around the mandrel 150 over the first strip 145 and the adhesive 135. In an embodiment, the cover 125 has a backing generally comprising polypropylene. A helical belt 120 driven by rollers 120a, 120b applies a compressive force on the cover material and advances the tubular assembly 115 down the mandrel 150. A flyaway saw 105 cuts the tubular assembly into lengths 110 that can be used, or cut and used to produce finished paint rollers.

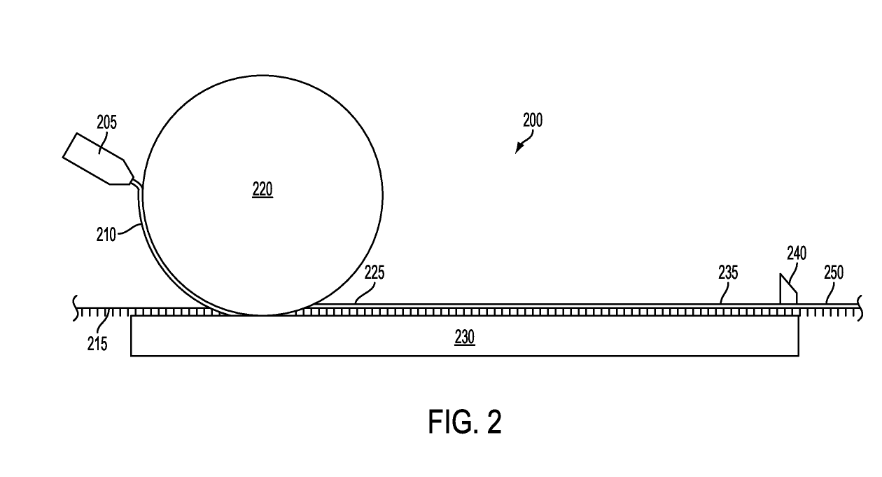

FIG. 2 shows an apparatus 200 for forming a composite paint roller cover 250 having a backing generally comprising polypropylene. The roller 220 is urged toward the frame 230 by a spring, by gravity or by other means that will be apparent to persons skilled in the art. A layer of adhesive 210 is dispensed by an applicator 205 onto a roller 220, and runs between the roller 220 and a frame 230, such as a tenter frame, or between the roller 220 and another roller (not shown). The layer of adhesive 210 generally comprising polypropylene is dispensed onto roller 220 may be between 0.010″ and 0.020″.

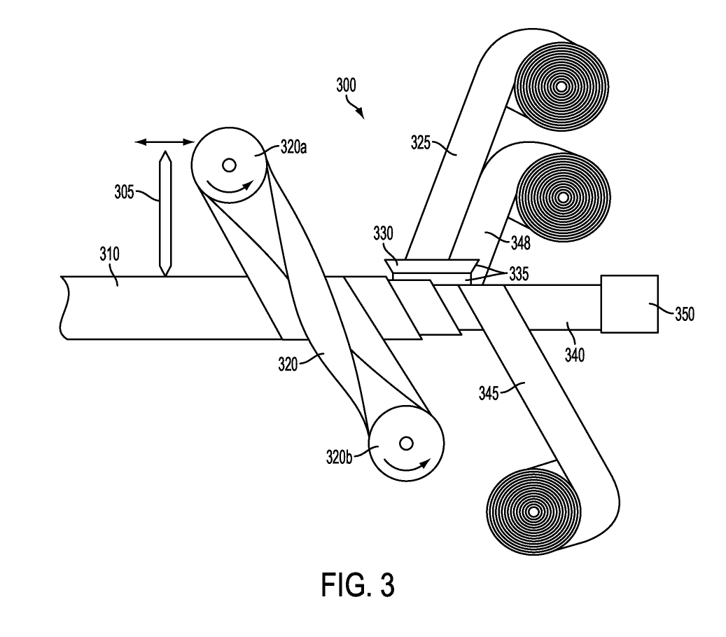

FIG. 3 shows a paint roller manufacturing apparatus 300. A strip of material 345 generally comprising polypropylene is wrapped helically about a mandrel 340 held on a base 350. The mandrel may be cooled by a cooler (not shown). A second strip of material 348 generally comprising polypropylene is wrapped helically about the first strip 345. An adhesive 335 generally comprising polypropylene is applied to an outer surface of the strips 345, 348 by applicator 330. A cover 325 is also helically wrapped around the mandrel 350 over the strips 345, 348 and the adhesive 335. In an embodiment, the cover 325 has a backing generally comprising polypropylene. A helical belt 320 driven by rollers 320a, 320b applies a compressive force on the cover material and advances the tubular assembly 310 down the mandrel 350. A flyaway saw 305 may cut the tubular assembly 310 into lengths (not shown) that can be used, or further cut and used to produce finished paint rollers.

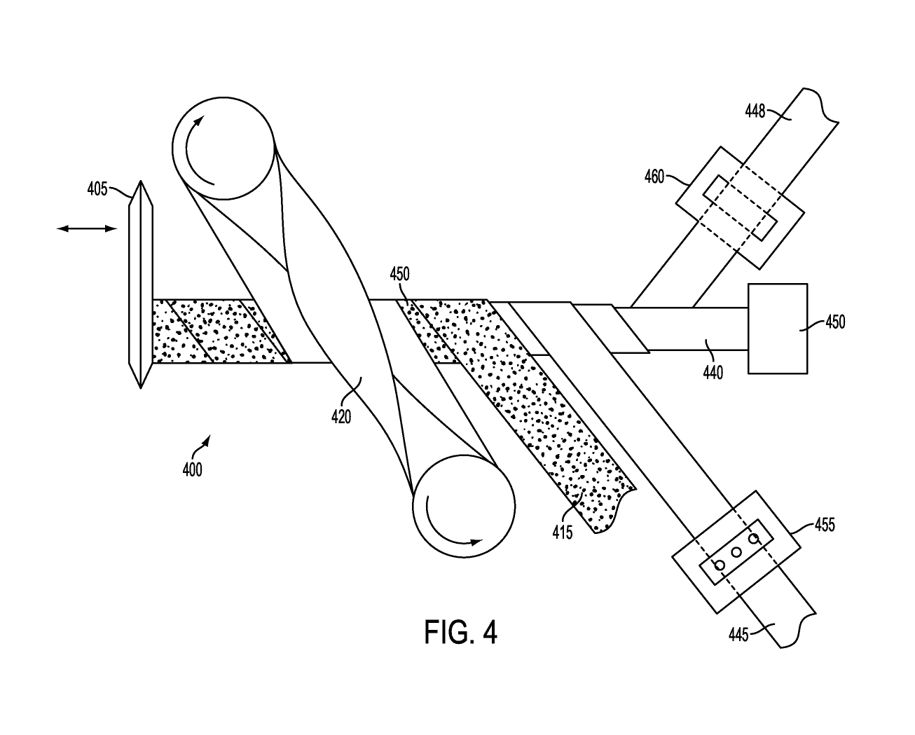

FIG. 4 shows a paint roller manufacturing apparatus 400. A first strip of material 448 and a second strip of material 445 each generally comprising polypropylene is wrapped helically about a mandrel 440 held on a base 450. The second strip of material 445 being wrapped helically about the first strip 448. The mandrel may be cooled by a cooler (not shown). The heaters 460, 455 which may employ heating elements or heat by open flame, heat the outer surface (vis-ä-vis the wrapping about the mandrel) of strips 448, 445 respectively. The heat produced by the heaters 460 is sufficient to cause the outer surface of the strips 448, 445 to become tacky, or to liquefy, or to become molten. (Although shown diagrammatically at a distance from the mandrel, in an embodiment, the heaters 460, 455 should be placed as close as practicable to the point where the strips 448, 445 contact the mandrel.) A cover 415 is also helically wrapped around the mandrel 440 over the outer surface of the second strip 445. In an embodiment, the cover 415 has a backing generally comprising polypropylene. A helical belt drive 420 applies an inwardly compressive force on the cover material 415 and advances the assembly down the mandrel 440. A flyaway saw 405 may cut the assembly into lengths (not shown) that can be used, or further cut and used to produce finished paint rollers.

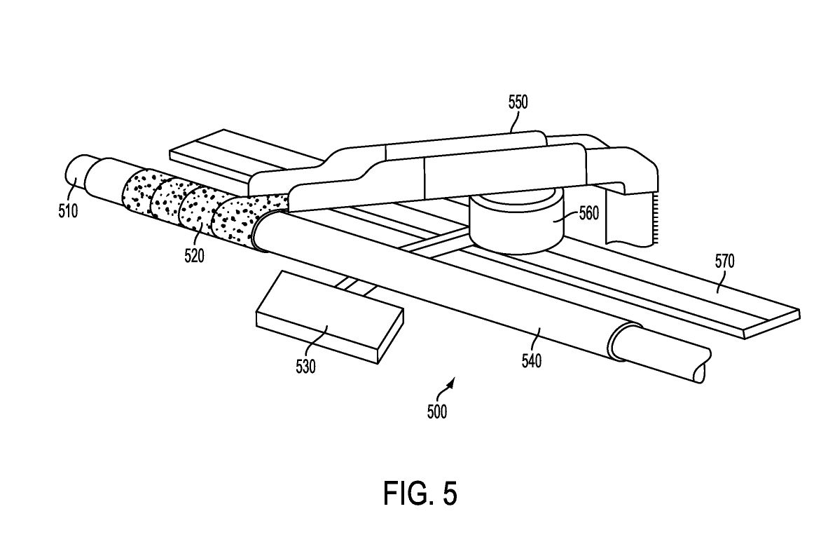

FIG. 5 shows an apparatus 500 suitable for making paint rollers with a preformed core. The apparatus 500 comprises a rotating mandrel 510, a carriage 560 running on a stationary track 570 and supporting a cover material guide 550, and a heater 530. A preformed core 540 comprising polypropylene which may be nucleated polypropylene is placed about the mandrel 510. The heater 530 is activated, thereby heat softening the outer surface of the preformed core in an amount sufficient to bond to the backing of the cover 520. The cover 520 is wrapped helically about the core by the rotation of the mandrel and the movement of the carriage 560. In an embodiment, the cover 520 has a backing generally comprising polypropylene. The rotation of the mandrel 510 and the movement of the carriage 560 are such that the cover 520 is wrapped about substantially all of the preformed core 540.

### Nucleated Strip Material

Referring to FIGS. 1, 3 and 4, in an embodiment, strips 145, 345, 348, 445 and 448 used in making a paint roller are made of a nucleated polypropylene. In an embodiment, a strip 145, 345, 348, 445, 448 is cut lengthwise from a sheet material (not shown) that is manufactured using nucleated polypropylene. In an embodiment, the thickness of the sheet material is determined by successive rollers. Nucleated polypropylene having an appropriate MFI can be run through successive rollers to reach a desired thickness for the sheet material. In an embodiment, the MFI of nucleated polypropylene extruded through rollers may be approximately 2. Almost any desired sheet thickness can be attained. In an embodiment, the sheet of nucleated polypropylene material having thickness of approximately 10 mil, 15 mil, 20 mil or 25 mil can be cut longitudinally into one or more strip 145, 345, 348, 445, 448 of a width appropriate for use in making paint rollers.

### Example Process Using Nucleated Strip

Referring now to FIG. 1, apparatus 100 may be operated according to the present invention using an adhesive 135 made from polypropylene, using a strip 145 made from a nucleated polypropylene and using a cover 125. A strip 145 comprising nucleated polypropylene is wrapped helically about a mandrel 140 held on a base 150. The mandrel may be cooled by a cooler (not shown). An adhesive 135 comprising polypropylene is applied to an outer surface of the strip 145 by applicator 130. A cover 125 is wrapped around the mandrel 150 over the first strip 145 and the adhesive 135. (Where the cover 125 is a strip of natural skin (e.g., lambskin) without a separate backing, the strip of cover material 125 used is slightly wider than the strip of microfiber or pile material would be used for the same application as the natural skin cover material is prone to shrinkage.) A helical belt 120 driven by rollers 120a, 120b applies a compressive force on the cover material and advances the tubular assembly 115 down the mandrel 150. A flyaway saw 105 cuts the tubular assembly into lengths 110 that can be used, or cut and used to produce finished paint rollers.

The amount of nucleation of the polypropylene used in the strip 145 may be varied without departing from the scope of the present disclosure. The use of nucleated polypropylene in the strip 145 achieves characteristics that, when compared to using non-nucleated polypropylene, will be increased as to stiffness of the finished roller when the roller is at an elevated temperature. Such an elevated temperature may occur if a finished roller is being cleaned, e.g., using hot water, or submerged or used in connection with another hot substance, such as a solvent, at an elevated temperature but not hotter than boiling water. Such an elevated temperature may also occur if a finished roller is being used to apply a heated fluid—fluids at a temperature making paint rollers made from strips of non-nucleated polypropylene undesirable due to softness. Elevated temperature may also occur if a finished roller is being used in a hot environment or for application of fluid to a hot surface.

Increased stiffness when at an elevated temperature may give a paint roller a firmer or stiffer feel, which may improve its performance as a paint roller if used at a higher temperature. Moreover, in many cases, stiffer or firmer paint rollers are typically sold at a higher price. To some degree, stiffness at an elevated temperature can be controlled, or a desired stiffness or range of stiffness can be achieved by varying the nucleation of the polypropylene.

In an embodiment, nucleated polypropylene can also be used in lieu of, or in combination with, non-nucleated polypropylene in the adhesive 135 and/or the backing for the cover 250. When so used, these application too are expected to achieve characteristics that, when compared to using non-nucleated polypropylene, will be increased as to stiffness of the finished roller when it is at an elevated temperature.

### Compound Strip Material

Referring to FIGS. 1, 3 and 4, in an embodiment, a strip 145, 345, 348, 445, 448 used in making a paint roller is made of a compound of nucleated polypropylene and calcium carbonate having between 5% and 66% calcium carbonate by weight. In an embodiment a strip 145, 345, 348, 445, 448 comprises at least 25% calcium carbonate by weight. In an embodiment a strip 145, 345, 348, 445, 448 comprises at least 50% calcium carbonate by weight.

A strip 145, 345, 348, 445, 448 may be cut lengthwise from a sheet material (not shown) that is manufactured using a compound of nucleated polypropylene and calcium carbonate. The thickness of a sheet of material may be determined by successive rollers. A compound of nucleated polypropylene and calcium carbonate having an appropriate MFI can be run through successive rollers to reach a desired thickness for the sheet material, and thus for the strip.

In an embodiment, the MFI of the polypropylene/calcium carbonate compound is approximately 2. Nucleated polypropylene TOTAL Polypropylene 4481WZ or a similar nucleated polypropylene having a melt flow index of approximately 4 may be compounded with approximately 60% by weight of calcium carbonate to achieve a resulting nucleated polypropylene/calcium carbonate compound having an MFI of approximately 2. This resulting compound can be run through successive rollers to reach a desired thickness for the sheet material. Almost any desired sheet thickness can be attained. In an embodiment, the sheet of polypropylene/calcium carbonate compound material having thickness of approximately 10 mil, 15 mil, 20 mil or 25 mil can be cut longitudinally into one or more strip 145, 345, 348, 445, 448 of a width appropriate for use in making paint rollers.

### Characteristics of Calcium Carbonate and Compounded Strips

In an embodiment, the calcium carbonate compounded with the nucleated polypropylene to form a strip 145, 345, 348, 445, 448 should be a relatively fine, powdered form of calcium carbonate. In an embodiment calcium carbonate compounded with nucleated polypropylene to form a sheet which is cut into one or more strips 145, 345, 348, 445, 448 should have a median particle size of 3 micrometers or less. In an embodiment, calcium carbonate compounded with nucleated polypropylene to form a sheet which is cut into one or more strips 145, 345, 348, 445, 448 may be surface treated.

The use of non-refined calcium carbonate, e.g., calcium carbonate that has not been surface treated, in combination with nucleated polypropylene adds strength to a resulting paint roller product when compared to a combination of refined calcium carbonate in combination with nucleated polypropylene. Thus, in an embodiment, the calcium carbonate compounded with nucleated polypropylene to form a sheet which is cut into one or more strips 145, 345, 348, 445, 448 is a non-refined calcium carbonate. In an embodiment, the non-refined calcium carbonate is used in compounding is in a relatively fine, powdered form. In an embodiment the calcium carbonate may have a median particle size of 3 micrometers or less.

In an embodiment, a twin screw extruder (not shown) may be used to compound non-refined calcium carbonate and nucleated polypropylene together and that compound may be used to form a sheet which is cut into one or more strips 145, 345, 348, 445, 448. The twin screw extruder may accept a supply of nucleated polypropylene, e.g., in pellet form, and a separate supply of calcium carbonate, e.g., in powered form.

The cost by weigh of calcium carbonate is expected to be lower than the cost by weigh of nucleated polypropylene, thus the use of a strip 145, 345, 348, 445, 448 comprising a compound of nucleated polypropylene and calcium carbonate is likely to reduce the cost of manufacturing paint rollers made therewith.

Strips 145, 345, 348, 445, 448 comprising a compound of nucleated polypropylene and calcium carbonate having between 5% and 66% calcium carbonate by weight is expected to have higher thermal conductivity than that of strips 145, 345, 348, 445, 448 made from nucleated polypropylene alone. Because of the higher thermal conductivity, using a strip 145, 345, 348 made from a compound of nucleated polypropylene and calcium carbonate having between 5% and 66% calcium carbonate by weight, rather than a strip 145, 345, 348 made from more than 95% nucleated polypropylene, is anticipated that an adhesive 135, 335 will set faster, and thus, an apparatus 100, 300 will operate at higher overall throughput than it would when using a strip 145, 345, 348, 445, 448 comprising more than 95% nucleated polypropylene. Similarly, the apparatus 400 is anticipated to operate at a higher throughput due to the higher thermal conductivity of a strip 445, 448 when one or more of the strips are made from a compound nucleated polypropylene and calcium carbonate having between 5% and 66% calcium carbonate by weight, rather than from more than 95% nucleated polypropylene,

### Example Single Strip Process Using Compounded Strip

Referring now to FIG. 1, apparatus 100 may be operated according to the present invention using an adhesive 135 made from polypropylene, using a compounded strip 145, (as described above, i.e., a strip 145 made from a nucleated polypropylene compounded with between 5% and 66% calcium carbonate by weight), and using a cover 125. (Where the cover 125 is a strip of natural skin (e.g., lambskin) without a separate backing, the strip of cover material 125 used is slightly wider than the strip of microfiber or pile material would be used for the same application as the natural skin cover material is prone to shrinkage.) In an embodiment, the compounded strip 145 comprises at least 25% calcium carbonate by weight. In an embodiment the compounded strip 145 comprises at least 50% calcium carbonate by weight. In an embodiment the compounded strip 145 comprises TOTAL Polypropylene 4481WZ or a similar nucleated polypropylene having a melt flow index of approximately 4 may be compounded with approximately 60% by weight of calcium carbonate to achieve a resulting nucleated polypropylene/calcium carbonate compound having an MFI of approximately 2. In an embodiment, the strip 145 has a thickness of approximately 10 mil, 15 mil, 20 mil or 25 mil and is 2⅞ inches wide.

Compounded strip 145 comprising nucleated polypropylene and between 5% and 66% calcium carbonate by weight is wrapped helically about a mandrel 140 held on a base 150. The mandrel may be cooled by a cooler (not shown). An adhesive 135 comprising polypropylene is applied to an outer surface of the strip 145 by applicator 130. A cover 125 is wrapped around the mandrel 150 over the compounded strip 145 and the adhesive 135. A helical belt 120 driven by rollers 120a, 120b applies a compressive force on the cover material and advances the tubular assembly 115 down the mandrel 150. A flyaway saw 105 cuts the tubular assembly into lengths 110 that can be used, or cut and used to produce finished paint rollers.

The amount of nucleation of the polypropylene used in the compounded strip 145 may be varied without departing from the scope of the present disclosure. The use of nucleated polypropylene in the compounded strip 145 achieves characteristics that, when compared to using non-nucleated polypropylene, will be increased as to stiffness of the finished roller when the roller is at an elevated temperature. The use of a compounded strip 145 comprising between 5% and 66% calcium carbonate achieves characteristics that, among other things, when compared to using a strip made without calcium carbonate, will be increased as to stiffness of the finished roller at non-elevated temperature.

Increased stiffness, regardless of the temperature, may give a paint roller a firmer or stiffer feel, which may improve its performance. Moreover, in many cases, stiffer or firmer paint rollers are typically sold at a higher price.

In an embodiment, a compound of nucleated polypropylene and between 5% and 66% calcium carbonate by weight can also be used in lieu of, or in combination with, non-nucleated polypropylene in the adhesive 135 and/or the backing for the cover 250. When so used, these application too achieve characteristics that, when compared to using non-nucleated polypropylene alone, will be increased as to stiffness of the finished roller.

It will be apparent to a person of skill in the art that, in view of the foregoing disclosure, any or all of the thermoplastic component parts of the paint roller, e.g., the adhesive 135 the strip 145 and the backing of the cover 125 may be made from a compound formed from nucleated polypropylene and between 5% and 66% calcium carbonate by weight. When more than one component part is made of a compound of nucleated polypropylene and calcium carbonate having between 5% and 66% calcium carbonate by weight, the percentage of calcium carbonate used in the compound forming the adhesive 135, the strip 145 and the cover 125 backing may be the same, or may differ from one-another. As the percentage of calcium carbonate may be varied, so too may the level of nucleation of the polypropylene.

### Compounding Adhesive

Referring to FIGS. 1 and 3, in an embodiment, an adhesive 135, 335 used in making a paint roller is formed from a compound of nucleated polypropylene and calcium carbonate having between 5% and 66% calcium carbonate by weight. In an embodiment an adhesive 135, 335 comprises at least 25% calcium carbonate by weight. In an embodiment an adhesive 135, 335 comprises approximately 45% calcium carbonate by weight.

The compound of nucleated polypropylene and calcium carbonate may be formed using a twin screw extruder (not shown) to compound calcium carbonate and nucleated polypropylene together and that compound may be used to supply the applicator 130, 330 directly, or alternatively to form a source for another extruder that supplies the applicator 130, 330. The twin screw extruder may accept a supply of nucleated polypropylene, e.g., in pellet form, and a separate supply of calcium carbonate, e.g., in powered form.

In an embodiment, the calcium carbonate compounded with the nucleated polypropylene to form a strip 145, 345, 348, 445, 448 should be a relatively fine, powdered form of calcium carbonate. In an embodiment, non-refined calcium carbonate, e.g., calcium carbonate that has not been surface treated, is used compounded with nucleated polypropylene. In an embodiment, the non-refined calcium carbonate is used in compounding is in a relatively fine, powdered form. In an embodiment the calcium carbonate may have a median particle size of 3 micrometers or less.

In an embodiment, the MFI of the nucleated polypropylene/calcium carbonate compound forming the adhesive is approximately 35 to provide for flow through the applicator 130, 330. Nucleated polypropylene 2180H or a similar nucleated polypropylene having a melt flow index of approximately 80 may be compounded with approximately 45% by weight of calcium carbonate to achieve a resulting nucleated polypropylene/calcium carbonate compound having an MFI of approximately 35. This resulting compound permits the compound to flow appropriately through the applicator 130, 330 in the process of making paint rollers.

### Example Two Strip Process Using Nucleated or Compounded Nucleated Strip

Referring now to FIG. 3, apparatus 300 may be operated according to the present disclosure using strips 345, 348 a cover 325 and an adhesive 335 comprising nucleated polypropylene or comprising nucleated polypropylene and calcium carbonate. The amount of nucleation of the polypropylene used in the adhesive 330 may be varied without departing from the scope of the present disclosure.

In an embodiment, the adhesive 335 has an MFI of between 20 and 50 to permit it to flow appropriately from the applicator 330. In an embodiment, the adhesive 335 has an MFI of approximately 35 to permit proper flow from the applicator 330 using a typical extruder (not shown).

In an embodiment, nucleated polypropylene 2180H or a similar nucleated polypropylene having a melt flow index of approximately 80 is compounded with approximately 45% by weight of calcium carbonate to achieve a resulting compound having an MFI of approximately 35. This compounded adhesive 335 can flow as adhesive through applicator 330 in the process of making paint rollers. The strips 345, 348 are wrapped helically about a mandrel 340, which may be cooled by a cooler (not shown). The mandrel 340 is held on a base 350. The compounded adhesive 335 is applied to an outer surface of the strips 345, 348 by applicator 330. A cover 325 is wrapped around the mandrel 340 over the strips 345, 348 and the compounded adhesive 335. A helical belt 320 driven by rollers 320a, 320b applies a compressive force on the cover material and advances the tubular assembly 310 down the mandrel 350. A flyaway saw 305 cuts the tubular assembly into lengths that can be used, or cut and used to produce finished paint rollers.

In an embodiment, nucleated polypropylene having a melt flow index of approximately 35 is used as an adhesive 335. The strips 345, 348 are wrapped helically about a mandrel 340, which may be cooled by a cooler (not shown). The mandrel 340 is held on a base 350. The adhesive 335 is applied to an outer surface of the strips 345, 348 by applicator 330. A cover 325 is wrapped around the mandrel 340 over the strips 345, 348 and the adhesive 335. A helical belt 320 driven by rollers 320a, 320b applies a compressive force on the cover material and advances the tubular assembly 310 down the mandrel 350. A flyaway saw 305 cuts the tubular assembly into lengths that can be used, or cut and used to produce finished paint rollers.

It will be apparent to a person of skill in the art that, in view of the foregoing disclosure, any or all of the thermoplastic component parts of the paint roller, e.g., the adhesive 335 the strips 345, 348 and the backing of the cover 325 may be made from a compound formed from nucleated polypropylene and between 5% and 66% calcium carbonate by weight. When more than one component part is made of a compound of nucleated polypropylene and calcium carbonate having between 5% and 66% calcium carbonate by weight, the percentage of calcium carbonate used in the compound forming the adhesive 335, the strips 345, 348 and the cover 325 backing may be the same, or may differ from one-another. As the percentage of calcium carbonate may be varied, so too may the level of nucleation of the polypropylene.

### Cover Material Made with Nucleated or Compounded Nucleated Polypropylene

In an embodiment, a cover 125, 250, 325, 425, 520 has a fabric backing and a pile outer surface such as knitted or woven cover materials; such a fabric backing of the cover 125, 250, 325, 425, 520 comprises interstitial pores into which an adhesive 135, 335, or liquefied or tacky base material 445, 540 may flow, especially when compressed by a belt 120, 320, 420. In an embodiment, a cover 125, 250, 325, 425, 520 is made from a microfiber material; such a microfiber cover 125, 250, 325, 425, 520 also comprises interstitial pores into which an adhesive 135, 335, or liquefied or tacky base material 445, 540 may flow, especially when compressed by a belt 120, 320, 420. In an embodiment, a cover 125, 250, 325, 425, 520 is made of a strip of natural skin, such as lambskin, sewn together to form a long strip. Natural skins, such as lambskin, comprises interstitial pores into which an adhesive 135, 335, or liquefied or tacky base material 445, 540 may flow, especially when compressed by a belt 120, 320, 420.

In an embodiment, a cover 125, 250, 325, 425, 520 has a pile, microfiber or fur outer surface and a smooth or uniformly imprinted backing formed from nucleated polypropylene or a compound of nucleated polypropylene and calcium carbonate. In an embodiment, the compound of nucleated polypropylene and calcium carbonate comprises between 5% and 66% calcium carbonate by weight.

In an embodiment, a cover 125, 250, 325, 425, 520 has a pile or microfiber outer surface and a smooth or uniformly imprinted backing formed from nucleated polypropylene or a compound of nucleated polypropylene and calcium carbonate. In an embodiment, the compound of nucleated polypropylene and calcium carbonate comprises between 5% and 66% calcium carbonate by weight.

### Example Process for Making Nucleated or Compounded Nucleated Cover

FIG. 2 shows an apparatus 200 for forming a composite paint roller cover 250 having a backing comprising nucleated polypropylene. The roller 220 is urged toward the frame 230 by a spring, by gravity or by other means that will be apparent to persons skilled in the art. A layer of adhesive 210 is dispensed by an applicator 205 onto a roller 220, and runs between the roller 220 and a frame 230, such as a tenter frame, or between the roller 220 and one or more other rollers (not shown). The layer of adhesive 210 dispensed onto roller 220 may have a thickness between 0.010″ and 0.020″. In an embodiment, the MFI of the adhesive 210 is greater than 50. In an embodiment, the MFI of the adhesive 210 falls within the range of approximately 80 to approximately 105.

In an embodiment, the adhesive 210 consists substantially entirely of nucleated polypropylene. Where the adhesive 210 consists substantially entirely of nucleated polypropylene, Pinnacle Polymers 2180H rated with an MFI of 80 may be used.

In another embodiment, the adhesive 210 is a compound of nucleated polypropylene and calcium carbonate having between 5% and 66% calcium carbonate by weight. Where the adhesive is a compound of nucleated polypropylene and calcium carbonate having between 5% and 66% calcium carbonate by weight, the adhesive 210 may be formed by a twin screw extruder sufficient for compounding calcium carbonate with nucleated polypropylene (not shown) from a supply of nucleated polypropylene resin in pellet form. The calcium carbonate used should be relatively non-abrasive to the processing machinery. In an embodiment, 2180H or a nucleated polypropylene having a similar MFI of 80 is compounded with 12% calcium carbonate by weight to achieve a compounded adhesive 210 having an MFI of approximately 70. In an embodiment, a nucleated polypropylene having an MFI of approximately 105 is compounded with 25% calcium carbonate by weight to achieve a compounded adhesive 210 having an MFI of approximately 80.

The cover material 215 is advanced along the frame 230 with its pile side down, and moved beneath the roller 220. In an embodiment, the cover material 215 has a pile side and a fabric backing—the fabric backing being porous and having interstitial spaces sufficient to permit penetration of the adhesive 210. In another embodiment, the cover material 215 lacks a separate fabric backing (e.g., microfiber), but the side opposite the pile side is porous and has interstitial spaces sufficient to permit penetration of the adhesive 210. In yet another embodiment, the cover material 215 has a fur side and a suede side, and the suede side is porous and has interstitial spaces sufficient to permit penetration of the adhesive 210.

An applicator 205 dispenses the adhesive 210. The positioning and angular orientation of the applicator 205 may be varied. In an embodiment, the applicator is angled between 30 degrees and 60 degrees from vertical and positioned within inches of the middle of the roller 220. In another embodiment the applicator 205 is within 30 degrees (+/−) of vertical, and is positioned to dispense adhesive such that the adhesive layer 210 first makes contact on the upper half of the roller 220. In yet another embodiment, the applicator 205 is within 30 degrees (+/−) of horizontal and is positioned to dispense adhesive such that the adhesive layer 210 first makes contact on the lower half of the roller 220. Variations in the angular orientation of the applicator 205, and its distance from and orientation around the roller are within the scope of the invention, and will be apparent to one skilled in the art.

As the cover material 215 and the layer of adhesive 210 pass between the roller 220 and the surface of the frame 230 they are urged together. The roller-side of the adhesive 210 may be smoothed or uniformly imprinted (e.g., embossed) by the roller 220 as it passed underneath, thus forming a uniform or smooth adhesive layer surface 225.

In an embodiment, the roller 220 may be heated. In an embodiment, the roller 220 may be cooled.

In an embodiment, the roller 220 applies a compressive force to urge the adhesive 210 towards the cover material 215. In an embodiment, the compressive force is sufficient to force the adhesive 210 into the interstitial spaces within the fabric backing of the cover material 215. The resulting composite sheet material 235 may be cut by a cutter 240 to trim away any excess materials, and thus to form the compound composite cover material 250 with a non-porous backing.

### Example Two Strip Process Using a Composite Paint Roller Cover

Apparatus 400 may be operated using a two strips 445, 448 and a composite paint roller cover 415 having a smoothed or uniformly imprinted backing comprising nucleated polypropylene. In an embodiment, the backing additionally comprises between 5% and 66% calcium carbonate by weight. The first strip of material 448 and the second strip of material 445 each generally comprising polypropylene is wrapped helically about a mandrel 440 held on a base 450. The second strip of material 445 being wrapped helically about the first strip 448. The mandrel may be cooled by a cooler (not shown). The heaters 460, 455 which may employ heating elements or heat by open flame, heat the outer surface (vis-ä-vis the wrapping about the mandrel) of the strips 448, 445 respectively. The heat produced by the heaters 460 is sufficient to cause the outer surface of the strips 448, 445 to become tacky, or to liquefy, or to become molten. (Although shown diagrammatically at a distance from the mandrel, in an embodiment, the heaters 460, 455 are placed as close as practicable to the point where the strips 448, 445 contact the mandrel.) A composite paint roller cover 415 having a smoothed or uniformly imprinted backing comprising nucleated polypropylene is also helically wrapped around the mandrel 440 over the outer surface of the second strip 445. A helical belt drive 420 applies an inwardly compressive force on the cover material 415 and advances the assembly down the mandrel 440 so that a flyaway saw 405 may cut the assembly into lengths (not shown) that can be used, or further cut and used to produce finished paint rollers.

It will be apparent to a person of skill in the art that, in view of the foregoing disclosure, any or all of the thermoplastic component parts of the paint roller, e.g., the strips 445, 448 and the backing of the composite paint roller cover 415 may be made from a compound formed from nucleated polypropylene and between 5% and 66% calcium carbonate by weight. When more than one component part is made of a compound of nucleated polypropylene and calcium carbonate having between 5% and 66% calcium carbonate by weight, the percentage of calcium carbonate used in the compound forming each strip 445, 448 and/or forming the composite paint roller cover 425 backing may be the same, or may differ from one-another. As the percentage of calcium carbonate may be varied, so too may the level of nucleation of the polypropylene.

### Example Preformed Core Process Using a Composite Paint Roller Cover

FIG. 5 shows an apparatus 500 suitable for making paint rollers with a preformed core. The apparatus 500 comprises a rotating mandrel 510, a carriage 560 running on a stationary track 570 and supporting a cover material guide 550, and a heater 530. A preformed core 540 comprising polypropylene (which may be nucleated polypropylene) is placed about the mandrel 510. The heater 530 is activated, thereby heat softening the outer surface of the preformed core in an amount sufficient to bond to the backing of a composite paint roller cover 520 having a smoothed or uniformly imprinted backing comprising nucleated polypropylene. The a composite paint roller cover 520 having a smoothed or uniformly imprinted backing comprising nucleated polypropylene is wrapped helically about the core by the rotation of the mandrel and the movement of the carriage 560. The rotation of the mandrel 510 and the movement of the carriage 560 are such that the a composite paint roller cover 520 is wrapped about substantially all of the preformed core 540. Either or both of the core 540 and/or the composite paint roller cover 520 may be formed from a compound comprising between 5% and 66% calcium carbonate by weight.

It will be apparent to a person of skill in the art that, in view of the foregoing disclosure, any or all of the thermoplastic component parts of the paint roller, e.g., the core 540 and the backing of the composite cover 520 may be made from a compound formed from nucleated polypropylene and between 5% and 66% calcium carbonate by weight. When more than one component part is made of a compound of nucleated polypropylene and calcium carbonate having between 5% and 66% calcium carbonate by weight, the percentage of calcium carbonate used in the compound forming the core 540 and the backing of the composite cover 520 backing may be the same, or may differ from one-another. As the percentage of calcium carbonate may be varied, so too may the level of nucleation of the polypropylene.

### Further Observations

It will be apparent to a person of skill in the art that, in view of the foregoing disclosure, any or all of the thermoplastic component parts of the paint roller may be made using nucleated polypropylene, and the level of nucleation of the polypropylene needn't be constant from one part to anther.

It will also be apparent to a person of skill in the art that, in view of the foregoing disclosure, any or all of the thermoplastic component parts of the paint roller may be made from a compound formed from polypropylene or from nucleated polypropylene, and in either case, between 5% and 66% calcium carbonate by weight. When more than one thermoplastic component of the paint roller is made of a compound comprising between 5% and 66% calcium carbonate by weight, the percentage of calcium carbonate used in the compound forming those several components may be the same, or may differ from one-another.

It is possible, without departing from the scope or spirit of the present disclosure to use nucleated polypropylene in lieu of polypropylene, in whole, or in part, in making paint rollers. In light of this disclosure, other methods for the manufacture of the paint rollers using at least a portion of which are made from nucleated polypropylene will be apparent to persons of skill in the art.

It also is possible, without departing from the scope or spirit of the present disclosure, to use a compound of polypropylene or nucleated polypropylene and calcium carbonate having between 5% and 66% calcium carbonate by weight in lieu of polypropylene in making paint rollers. In light of this disclosure, other methods for the manufacture of the same will be apparent to persons of skill in the art.

Benefits of certain embodiments of the instant invention include: control of thermal conductivity in the component materials leading to faster throughput and/or faster set times; and control of material characteristics such as stiffness for manufacture of harder, more expensive paint rollers.

Benefits of certain embodiments of the instant invention include: control of the heat deflection temperature in the component materials leading to paint rollers able to withstand higher temperatures in use and during cleaning; and control of material characteristics such as stiffness for manufacture of harder, more expensive paint rollers.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention, and has disclosed the ways the inventor now believes are the best ways to practice the invention. The above description and drawings are merely illustrative of the present invention and that changes in components, structure and procedure are possible without departing from the scope of the present invention as defined in the claims below.

### Illustrative Embodiments Shown in the Figures

In an embodiment, a paint roller is made using a strip formed by compounding TOTAL Polypropylene 4481 WA or another nucleated polypropylene having an MFI of approximately 4 and approximately 60% calcium carbonate by weight.

In an embodiment, a paint roller is made using two strips formed by compounding TOTAL Polypropylene 4481 WA or another nucleated polypropylene having an MFI of approximately 4 and approximately 60% calcium carbonate by weight.

In an embodiment, a paint roller is made using an adhesive formed by compounding Pinnacle Polymers 2180H or another nucleated polypropylene having an MFI of approximately 80 and approximately 45% calcium carbonate by weight.

In an embodiment, a paint roller is made using at least one strip formed by compounding TOTAL Polypropylene 4481 WA or another nucleated polypropylene having an MFI of approximately 4 and approximately 60% calcium carbonate by weight; an adhesive formed by compounding Pinnacle Polymers 2180H or another nucleated polypropylene having an MFI of approximately 80 and approximately 45% calcium carbonate by weight; and composite cover having a backing comprising Pinnacle Polymers 2180H or another nucleated polypropylene having an MFI of approximately 80.

In one embodiment a strip of material is helically wound around a mandrel so as to form a helically wound strip. The strip is formed from nucleated polypropylene. The wound strip is advanced along the mandrel. A layer of adhesive is applied onto an outer surface of the wound strip. A strip of cover material then is helically wrapped about the wound strip and over the layer of adhesive, thereby bonding the strip of cover material to the wound strip for forming the paint roller.

In one embodiment, a strip of material is helically wound around a mandrel so as to form a helically wound strip. The strip is formed from nucleated polypropylene. The wound strip is advanced along the mandrel. A layer of adhesive is applied onto an outer surface of the wound strip. A strip of cover material then is helically wrapped about the wound strip and over the layer of adhesive, thereby bonding the strip of cover material to the wound strip for forming the paint roller.

In another embodiment a strip of material is helically wound around a mandrel so as to form a helically wound strip. The wound strip is advanced along the mandrel. An adhesive formed from nucleated polypropylene. The layer of adhesive is applied onto an outer surface of the wound strip. A strip of cover material then is helically wrapped about the wound strip and over the layer of adhesive, thereby bonding the strip of cover material to the wound strip for forming the paint roller.

In another embodiment a strip of material helically wound around a mandrel so as to form a helically wound strip. The strip is formed from nucleated polypropylene. The wound strip is advanced along the mandrel. An adhesive is made from nucleated polypropylene. A layer of the adhesive is applied onto an outer surface of the wound strip. A strip of cover material then is helically wrapped about the wound strip and over the layer of adhesive, thereby bonding the strip of cover material to the wound strip for forming the paint roller.

In an embodiment an inner strip and an outer strip of material is helically advanced about a mandrel in offset relation. At least one of the strips is formed from nucleated polypropylene. A layer of adhesive is applied between the two strips and on the outer surface of the outer strip. Prior to permitting the layer of adhesive to harden and set, a cover is wrapped around the outer strip and a compressing force is applied upon the cover urging the cover and the two strips toward the mandrel, thereby creating the continuous laminated paint roller.

In another embodiment an inner strip and an outer strip of material is helically advanced about a mandrel in offset relation. An adhesive material is made from nucleated polypropylene. The adhesive material is applied between the two strips and on the outer surface of the outer strip. Prior to permitting the adhesive material to harden and set, a cover is wrapped around the outer strip and a compressing force is applied upon the cover urging the cover and the two strips toward the mandrel, thereby creating the continuous laminated paint roller.

In another embodiment an inner strip and an outer strip of material is helically advanced about a mandrel in offset relation, at least one of the strips being formed from nucleated polypropylene. An adhesive material is also formed from nucleated polypropylene. The adhesive material is applied between the two strips and on the outer surface of the outer strip. Prior to permitting the layer of adhesive to harden and set, a cover is wrapped around the outer strip and a compressing force is applied upon the cover urging the cover and the two strips toward the mandrel, thereby creating the continuous laminated paint roller.

In another embodiment a first width of applicator material is advanced. The cover material has an applicator side and a backing side, wherein the backing on the backing side is porous, having interstitial spaces or gaps. An adhesive is made from nucleated polypropylene. A layer of the adhesive is applied to the backing side of the applicator material. The adhesive layer is allowed to set to form a composite sheet material having an applicator side and a non-porous backing. The composite sheet material is longitudinally cut to form one or more strips of composite cover material in a second width. The formed composite cover material has an inner surface and an outer surface, the outer surface comprising an exposed pile, fur or microfiber, and the inner surface comprising a non-porous layer.

In another embodiment an adhesive material is made from nucleated polypropylene. The adhesive material is applied between a cover material and one or more materials making up the paint roller core. The adhesive material is permitted to harden and set, thereby creating the paint roller.

In another embodiment a strip comprising nucleated polypropylene is helically wound around a mandrel so as to form a helically wound strip, the strip having an outer surface. The wound strip is helically advanced along the mandrel. A layer of adhesive comprising nucleated polypropylene is applied onto the outer surface of the wound strip. A strip of composite cover material is then wrapped about the wound strip and over the layer of adhesive. The composite cover material is formed by method comprising the following steps. A width of porous applicator material is provided having an applicator side and an underside. The width of applicator material is advanced with the underside facing up. A backing layer is made from nucleated polypropylene. The backing layer is applied on the underside of the advancing width of applicator material so that the layer has one side that is in contact with the underside of the advancing material and an other side that is not in contact with the advancing applicator material, the layer being in molten form when it is applied. A compressive force is applied to the other side of the layer before the layer hardens and sets, to smooth the other side of the layer of nucleated polypropylene, and to urge the layer and the underside of the applicator material together, thereby forming a composite material having a smooth or uniformly imprinted non-porous side and an exposed applicator side. In an embodiment, pile is held fast by the set adhesive. The width of composite material is cut into a strip once the backing layer is no longer in molten form, thereby forming a composite cover material having an inner surface comprising a smooth or uniformly imprinted non-porous nucleated polypropylene side and a pile side. The composite cover material produced by the method described above is then used to form a laminated pain roller. A compressive force is applied from without the composite cover material to urge the composite cover material, the layer of adhesive and strip of non-porous nucleated polypropylene material together, thereby laminating the smooth inner surface of the composite cover material to the outer surface of the non-porous nucleated polypropylene strip.

In another embodiment an inner strip of thermoplastic material is helically around a mandrel so as to form a helically wound inner strip, the inner strip having an outer surface. A second strip of thermoplastic material is helically wound around a mandrel in offset relation to the inner strip, so as to form a helically wound second strip, the second strip having an inner surface and an outer surface. The wound inner and second strips are advanced along the mandrel. An adhesive is made from nucleated polypropylene. A layer of the adhesive is applied onto the outer surface of the wound inner strip and the outer surface of the wound second strip. A strip of composite cover material is then wrapped about the wound second strip and over the layer of adhesive applied to the wound second strip. The composite cover material has an inner surface and an outer surface, the outer surface comprising a pile fabric, and the inner surface comprising a smooth generally non-porous backing comprising nucleated polypropylene. A compressive force is then applied from without the composite cover material to urge the composite cover material, the layer of adhesive and inner and second strips together, thereby laminating the inner surface of the composite cover material to the outer surface of the second strip and laminating the inner surface of the second strip to the outer surface of the inner strip.

In another embodiment an inner strip and an outer strip of material is helically advanced about a mandrel in offset relation. At least one of the strips is formed from nucleated polypropylene. The inner strip and the outer strip have an outer surface facing away from the mandrel. The outer surface of the inner and outer strips is heated to cause a layer of the outer surface of the strips to become liquefied. Prior to permitting the liquefied layers to harden and set, a cover around is wrapped around the outer strip and a compressing force is applied upon the cover urging the cover and the two strips toward the mandrel, thereby creating the continuous laminated paint roller.

In another embodiment a cold hard hollow core is provided. The cold hard hollow core is formed from nucleated polypropylene. A mandrel having an external diameter is provided. The mandrel slidably receives and makes contact with the cold hard hollow core. The cold hard hollow core is rotated. The exterior surface of the cold hard hollow thermoplastic rotating core is heated, by application of a single source of heat, to a temperature high enough to cause subsequently applied cover to adhere to said exterior surface. A cover is then to the heated exterior surface of the cold hard hollow thermoplastic core, thereby bonding the cover to the heated exterior surface thereof, and forming a paint roller.

In yet another embodiment a strip of material is helically wound around a mandrel so as to form a helically wound strip. The strip is formed from a compound of nucleated polypropylene and calcium carbonate having between 5% and 66% calcium carbonate by weight. The wound strip is advanced along the mandrel. A layer of adhesive is applied onto an outer surface of the wound strip. A strip of cover material then is helically wrapped about the wound strip and over the layer of adhesive, thereby bonding the strip of cover material to the wound strip for forming the paint roller.

In another embodiment a strip of material is helically wound around a mandrel so as to form a helically wound strip. The wound strip is advanced along the mandrel. An adhesive is compounded from nucleated polypropylene and calcium carbonate. The compound comprises between 5% and 66% calcium carbonate by weight. The layer of adhesive is applied onto an outer surface of the wound strip. A strip of cover material then is helically wrapped about the wound strip and over the layer of adhesive, thereby bonding the strip of cover material to the wound strip for forming the paint roller.

In another embodiment a strip of material helically wound around a mandrel so as to form a helically wound strip. The strip is formed from a compound of nucleated polypropylene and calcium carbonate having between 5% and 66% calcium carbonate by weight. The wound strip is advanced along the mandrel. An adhesive is compounded from nucleated polypropylene and calcium carbonate. The compound comprises between 5% and 66% calcium carbonate by weight. The layer of adhesive is applied onto an outer surface of the wound strip. A strip of cover material then is helically wrapped about the wound strip and over the layer of adhesive, thereby bonding the strip of cover material to the wound strip for forming the paint roller.

In another embodiment an inner strip and an outer strip of material is helically advanced about a mandrel in offset relation. At least one of the strips is formed from a compound of nucleated polypropylene and calcium carbonate having between 5% and 66% calcium carbonate by weight. A layer of adhesive is applied between the two strips and on the outer surface of the outer strip. Prior to permitting the layer of adhesive to harden and set, a cover is wrapped around the outer strip and a compressing force is applied upon the cover urging the cover and the two strips toward the mandrel, thereby creating the continuous laminated paint roller.

In another embodiment an inner strip and an outer strip of material is helically advanced about a mandrel in offset relation. An adhesive material is compounded from nucleated polypropylene and calcium carbonate, the compound comprising between 5% and 66% calcium carbonate by weight. The adhesive material is applied between the two strips and on the outer surface of the outer strip. Prior to permitting the adhesive material to harden and set, a cover is wrapped around the outer strip and a compressing force is applied upon the cover urging the cover and the two strips toward the mandrel, thereby creating the continuous laminated paint roller.

In another embodiment an inner strip and an outer strip of material is helically advanced about a mandrel in offset relation, at least one of the strips being formed from a compound of polypropylene and calcium carbonate having between 5% and 66% calcium carbonate by weight. An adhesive material is compounded from nucleated polypropylene and calcium carbonate. The compound comprises between 5% and 66% calcium carbonate by weight. The adhesive material is applied between the two strips and on the outer surface of the outer strip. Prior to permitting the layer of adhesive material to harden and set, a cover is wrapped around the outer strip and a compressing force is applied upon the cover urging the cover and the two strips toward the mandrel, thereby creating the continuous laminated paint roller.

In another embodiment a first width of applicator material is advanced. The applicator material has an applicator side and a backing side, wherein the backing side is porous, having interstitial spaces or gaps. An adhesive is compounded from nucleated polypropylene and calcium carbonate. The compound comprises between 5% and 66% calcium carbonate by weight. A layer of the adhesive is applied to the backing side of the applicator material. The adhesive layer is allowed to set to form a composite sheet material having an exposed applicator side and a non-porous backing. The composite sheet material is longitudinally cut to form one or more strips of composite cover material in a second width. The formed composite cover material has an inner surface and an outer surface, the outer surface comprising an exposed applicator side, and the inner surface comprising a non-porous layer.

In another embodiment an adhesive material is compounded from nucleated polypropylene and calcium carbonate. The compound comprises between 5% and 66% calcium carbonate by weight. The adhesive material is applied between a cover material and one or more materials making up the paint roller core. The adhesive material is permitted to harden and set, thereby creating the paint roller.

In another embodiment a strip comprising nucleated polypropylene is helically wound around a mandrel so as to form a helically wound strip, the strip having an outer surface. The wound strip is helically advanced along the mandrel. A layer of adhesive comprising nucleated polypropylene is applied onto the outer surface of the wound strip. A strip of composite cover material is then wrapped about the wound strip and over the layer of adhesive. The composite cover material is formed by method comprising the following steps. A width of porous pile material is provided having a pile side and an fabric underside. The width of pile material is advanced with the fabric underside facing up. A backing layer is compounded from nucleated polypropylene and calcium carbonate, the compound comprising between 5% and 66% calcium carbonate by weight. The backing layer is applied on the fabric underside of the advancing width of pile material so that the layer has one side that is in contact with the fabric underside of the advancing material and an other side that is not in contact with the advancing pile material, the layer being in molten form when it is applied. A compressive force is applied to the other side of the layer before the layer hardens and sets, to smooth the other side of the layer of nucleated polypropylene, and to urge the layer and the fabric underside of the pile material together, thereby forming a composite material having a smooth or uniformly imprinted non-porous side and a pile side, and wherein the pile is held fast on the composite material. The width of composite material is cut into a strip once the backing layer is no longer in molten form, thereby forming a composite cover material having an inner surface comprising a smooth or uniformly imprinted non-porous nucleated polypropylene side and a pile side. The composite cover material produced by the method described above is then used to form a laminated pain roller. A compressive force is applied from without the composite cover material to urge the composite cover material, the layer of adhesive and strip of non-porous nucleated polypropylene material together, thereby laminating the smooth inner surface of the composite cover material to the outer surface of the non-porous nucleated polypropylene strip.

In another embodiment an inner strip of thermoplastic material is helically around a mandrel so as to form a helically wound inner strip, the inner strip having an outer surface. A second strip of thermoplastic material is helically wound around a mandrel in offset relation to the inner strip, so as to form a helically wound second strip, the second strip having an inner surface and an outer surface. The wound inner and second strips are advanced along the mandrel. An adhesive is compounded from nucleated polypropylene and calcium carbonate, the compound comprising between 5% and 66% calcium carbonate by weight. A layer of the adhesive is applied onto the outer surface of the wound inner strip and the outer surface of the wound second strip. A strip of composite cover material is then wrapped about the wound second strip and over the layer of adhesive applied to the wound second strip. The composite cover material has an inner surface and an outer surface, the outer surface comprising an applicator side, and the inner surface comprising a smooth generally non-porous backing comprising nucleated polypropylene. A compressive force is then applied from without the composite cover material to urge the composite cover material, the layer of adhesive and inner and second strips together, thereby laminating the inner surface of the composite cover material to the outer surface of the second strip and laminating the inner surface of the second strip to the outer surface of the inner strip.

In another embodiment an inner strip and an outer strip of material is helically advanced about a mandrel in offset relation. At least one of the strips is formed from a compound of nucleated polypropylene and calcium carbonate having between 5% and 66% calcium carbonate by weight. The inner strip and the outer strip have an outer surface facing away from the mandrel. The outer surface of the inner and outer strips is heated to cause a layer of the outer surface of the strips to become liquefied. Prior to permitting the liquefied layers to harden and set, a cover around is wrapped around the outer strip and a compressing force is applied upon the cover urging the cover and the two strips toward the mandrel, thereby creating the continuous laminated paint roller.

In another embodiment a cold hard hollow core is provided. The cold hard hollow core is formed from a compound of nucleated polypropylene and calcium carbonate having between 5% and 66% calcium carbonate by weight. A mandrel having an external diameter is provided. The mandrel slidably receives and makes contact with the cold hard hollow core. The cold hard hollow core is rotated. The exterior surface of the cold hard hollow thermoplastic rotating core is heated, by application of a single source of heat, to a temperature high enough to cause subsequently applied cover to adhere to said exterior surface. A cover is then to the heated exterior surface of the cold hard hollow thermoplastic core, thereby bonding the cover to the heated exterior surface thereof, and forming a paint roller.

These above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention, and has disclosed the ways the inventor now believes are the best ways to practice the invention. The above description and drawings are merely illustrative of the present invention and that changes in components, structure and procedure are possible without departing from the scope of the present invention as defined in the following claims. Thus, while the invention has been particularly shown and described with reference to embodiments thereof, it will be understood by those skilled in the art that various changes in form and details may be made therein without departing from the spirit and scope of the invention. The above embodiments are illustrative of the present invention. It is neither necessary, nor intended for this patent to outline or define every possible combination or embodiment.

What is claimed is:

1. A method of making a paint roller, comprising the steps of:
helically winding a strip of material around a mandrel so as to form a helically wound strip, the strip comprising nucleated polypropylene;
advancing the wound strip along the mandrel;
applying a layer of adhesive onto an outer surface of the wound strip; and
helically wrapping a strip of cover material about the wound strip and over the layer of adhesive, thereby bonding the strip of cover material to the wound strip for forming the paint roller.

2. The method of claim 1, wherein the strip of cover material is made from lambskin.

3. The method of claim 1, wherein the strip comprising nucleated polypropylene is formed from a compound comprising nucleated polypropylene and calcium carbonate having at least 5% but not more than 66% calcium carbonate by weight.

4. The method of claim 2, wherein the strip comprising nucleated polypropylene is formed from a compound comprising nucleated polypropylene and calcium carbonate having at least 50% but not more than 66% calcium carbonate by weight.

5. The method of claim 3, wherein the strip comprising nucleated polypropylene comprises at least 33% nucleated polypropylene by weight.

6. A method of making a paint roller, comprising the steps of:
helically winding a strip of material around a mandrel so as to form a helically wound strip;
advancing the wound strip along the mandrel;
extruding a layer of adhesive from a supply comprising nucleated polypropylene;
applying the layer of adhesive onto an outer surface of the wound strip;
helically wrapping a strip of cover material about the wound strip and over the layer of adhesive, thereby bonding the strip of cover material to the wound strip for forming the paint roller.

7. The method of claim 6, wherein the strip of cover material is made from lambskin.

8. The method of claim 6, wherein the supply comprising nucleated polypropylene is formed from a compound comprising nucleated polypropylene and calcium carbonate having at least 5% but not more than 66% calcium carbonate by weight.

9. The method of claim 7, wherein the supply comprising nucleated polypropylene is formed from a compound comprising nucleated polypropylene and calcium carbonate having at least 50% but not more than 66% calcium carbonate by weight.

10. The method of claim 8, wherein the supply comprising nucleated polypropylene the comprises at least 33% nucleated polypropylene by weight.

11. A method of making a paint roller, comprising the steps of:
helically winding a strip of material around a mandrel so as to form a helically wound strip, the strip being formed from nucleated polypropylene;
advancing the wound strip along the mandrel;
extruding a layer of adhesive from a supply comprising nucleated polypropylene;
applying the layer of adhesive onto an outer surface of the wound strip;
helically wrapping a strip of cover material about the wound strip and over the layer of adhesive, thereby bonding the strip of cover material to the wound strip for forming the paint roller.

12. The method of claim 11, wherein the strip of cover material is made from lambskin.

13. The method of claim 11, wherein the supply comprising nucleated polypropylene is formed from a compound comprising nucleated polypropylene and calcium carbonate having at least 5% but not more than 66% calcium carbonate by weight.

14. The method of claim 12, wherein the supply comprising nucleated polypropylene is formed from a compound comprising nucleated polypropylene and calcium carbonate having at least 50% but not more than 66% calcium carbonate by weight.

15. The method of claim 14, wherein the supply comprising nucleated polypropylene comprises at least 33% nucleated polypropylene by weight.

16. A method for continuously producing a multi-strip laminate paint roller comprising the steps of:
helically advancing an inner strip and an outer strip of material about a mandrel in offset relation, at least one of the strips comprising nucleated polypropylene;
applying a layer of adhesive between the two strips and on the outer surface of the outer strip;
prior to permitting the layer of liquid polypropylene to harden and set, wrapping a cover around the outer strip and applying a compressing force upon the cover urging the cover and the two strips toward the mandrel, thereby creating the continuous laminated paint roller.

17. The method of claim 16, wherein the cover is made from lambskin.

18. The method of claim 16, wherein the at least one of the strips comprising nucleated polypropylene is formed from a compound comprising nucleated polypropylene and calcium carbonate having at least 5% but not more than 66% calcium carbonate by weight.

19. The method of claim 17, wherein the at least one of the strips comprising nucleated polypropylene is formed from a compound comprising nucleated polypropylene and calcium carbonate having at least 50% but not more than 66% calcium carbonate by weight.

20. The method of claim 19, wherein the at least one of the strips comprising nucleated polypropylene comprises at least 33% nucleated polypropylene by weight.

21. A method for continuously producing a multi-strip laminate paint roller comprising the steps of:
helically advancing an inner strip and an outer strip of material about a mandrel in offset relation;
forming a layer of adhesive from a supply comprising nucleated polypropylene;
applying the layer of adhesive material between the two strips and on the outer surface of the outer strip;
prior to permitting the adhesive material to harden and set, wrapping a cover around the outer strip and applying a compressing force upon the cover urging the cover and the two strips toward the mandrel, thereby creating the continuous laminated paint roller.

22. The method of claim 21, wherein the cover is made from lambskin.

23. The method of claim 21, wherein the step of forming a layer of adhesive from a supply comprising nucleated polypropylene is performed using an extruder.

24. The method of claim 21, wherein the supply comprising nucleated polypropylene is formed from a compound comprising nucleated polypropylene and calcium carbonate having at least 5% but not more than 66% calcium carbonate by weight.

25. The method of claim 22, wherein supply comprising nucleated polypropylene is formed from a compound comprising nucleated polypropylene and calcium carbonate having at least 50% but not more than 66% calcium carbonate by weight.

26. The method of claim 24, wherein the supply comprising nucleated polypropylene comprises at least 33% nucleated polypropylene by weight.

27. A method for continuously producing a multi-strip laminate paint roller comprising the steps of:
helically advancing an inner strip and an outer strip of material about a mandrel in offset relation, at least one of the strips comprising nucleated polypropylene;
forming a layer of adhesive from a supply comprising nucleated polypropylene;
applying the adhesive material between the two strips and on the outer surface of the outer strip;
prior to permitting the layer of liquid polypropylene to harden and set, wrapping a cover around the outer strip and applying a compressing force upon the cover urging the cover and the two strips toward the mandrel, thereby creating the continuous laminated paint roller.

28. The method of claim 27, wherein the cover is made from lambskin.

29. The method of claim 27, wherein the step of forming a layer of adhesive from a supply comprising nucleated polypropylene is performed using an extruder.

30. The method of claim 27, wherein the at least one of the strips comprising nucleated polypropylene is formed from a compound comprising nucleated polypropylene and calcium carbonate having at least 5% but not more than 66% calcium carbonate by weight.

31. The method of claim 30, wherein the at least one of the strips comprising nucleated polypropylene is formed from a compound comprising nucleated polypropylene and calcium carbonate having at least 50% but not more than 66% calcium carbonate by weight.

32. The method of claim 31, wherein the at least one of the strips comprising nucleated polypropylene comprises at least 33% nucleated polypropylene by weight.

33. The method of claim 27, wherein the supply comprising nucleated polypropylene is formed from a compound comprising nucleated polypropylene and calcium carbonate having at least 5% but not more than 66% calcium carbonate by weight.

34. The method of claim 33, wherein the supply comprising nucleated polypropylene is formed from a compound comprising nucleated polypropylene and calcium carbonate having at least 50% but not more than 66% calcium carbonate by weight.

35. The method of claim 34, wherein the supply comprising nucleated polypropylene comprises at least 33% nucleated polypropylene by weight.

36. A method of making a paint roller having one or more materials making up its core, the method comprising the steps of:
forming an adhesive material from a pellet supply, the pellets comprising nucleated polypropylene;
applying the adhesive material between a cover material and one or more other materials, which, with the adhesive, make a continuous paint roller;
permitting the adhesive material to harden and set, thereby creating the paint roller.

37. The method of claim 36, wherein the cover material is made from lambskin.

38. The method of claim 36, wherein the step of forming a layer of adhesive from a supply comprising nucleated polypropylene is performed using an extruder.

39. The method of claim 36, wherein the supply comprising nucleated polypropylene is formed from a compound comprising nucleated polypropylene and calcium carbonate having at least 5% but not more than 66% calcium carbonate by weight.

40. The method of claim 36, wherein the supply comprising nucleated polypropylene is formed from a compound comprising nucleated polypropylene and calcium carbonate having at least 50% but not more than 66% calcium carbonate by weight.

41. The method of claim 40, wherein the supply comprising nucleated polypropylene comprises at least 33% nucleated polypropylene by weight.

42. The method of claim 36, wherein the pellets comprising nucleated polypropylene are formed using a twin screw extruder, and the twin screw extruder compounds the a supply comprising nucleated polypropylene and a supply comprising calcium carbonate.

43. The method of claim 43, wherein the pellets comprise at least 33% nucleated polypropylene by weight and at least 50% but not more than 66% calcium carbonate by weight.

44. A method of making a laminated paint roller comprising the steps of:
helically winding a strip comprising nucleated polypropylene around a mandrel so as to form a helically wound strip, the strip having an outer surface;
advancing the wound strip along the mandrel;
applying a layer of adhesive comprising nucleated polypropylene onto the outer surface of the wound strip; and
wrapping a strip of composite cover material about the wound strip and over the layer of adhesive, the composite cover material being formed by the steps of:
providing a width of porous material having an applicator side and an underside;
advancing the width of material with the underside facing up;
applying a backing layer comprising nucleated polypropylene on the underside of the advancing width of material so that the layer has one side that is in contact with the underside of the advancing material and an other side that is not in contact with the advancing material, the layer being in molten form when it is applied;
applying a compressive force to the other side of the layer before the layer hardens and sets, to smooth the other side of the backing layer, and to urge the backing layer and the underside of the material together, thereby forming a composite material having a smooth or uniformly imprinted non-porous side and an exposed applicator side;
cutting the width of composite material into a strip once the backing layer is no longer in molten form, thereby forming a composite cover material having an inner surface comprising a smooth or uniformly imprinted non-porous side and an exposed applicator side; and
applying a compressive force from without the composite cover material to urge the composite cover material, the layer of adhesive and strip of non-porous material together, thereby laminating the inner surface of the composite cover material to the outer surface of the strip.

45. The method of claim 44, wherein the applicator side of the material is a pile side, and the underside of the material is a fabric backing, and wherein at least a portion of the pile is held fast on the composite material by the set adhesive.

46. The method of claim 44, wherein the material is a microfiber material.

47. The method of claim 44, wherein the material is a natural skin material.

48. The method of claim 44, wherein the material is lambskin.

49. A method of making a laminated paint roller comprising the steps of:
helically winding an inner strip of thermoplastic material around a mandrel so as to form a helically wound inner strip, the inner strip having an outer surface;
helically winding a second strip of thermoplastic material around a mandrel in offset relation to the inner strip, so as to form a helically wound second strip, the second strip having an inner surface and an outer surface;
advancing the wound inner and second strips along the mandrel;
extruding an adhesive from nucleated polypropylene and calcium carbonate, the compound comprising at least 50% but not more than 66% calcium carbonate by weight;
applying a layer of the adhesive onto the outer surface of the wound inner strip and the outer surface of the wound second strip; and
wrapping a strip of composite cover material about the wound second strip and over the layer of adhesive applied to the wound second strip, the composite cover material having an inner surface and an outer surface, the outer surface of the composite cover material comprising a pile fabric, and the inner surface comprising a smooth generally non-porous backing comprising polypropylene; and
applying a compressive force from without the composite cover material to urge the composite cover material, the layer of adhesive and inner and second strips together, thereby laminating the inner surface of the composite cover material to the outer surface of the second strip and laminating the inner surface of the second strip to the outer surface of the inner strip.

50. The method claimed in claim 46, wherein the composite cover material comprises lambskin.

51. A method for continuously producing a multi-strip laminate paint roller comprising the steps of:
helically advancing an inner strip and an outer strip of material about a mandrel in offset relation, at least one of the strips being formed from nucleated, the inner strip and the outer strip having an outer surface facing away from the mandrel;
heating the outer surface of the inner and outer strips to cause a layer of the outer surface of the strips to become liquefied;
prior to permitting the liquefied layers to harden and set, wrapping a cover around the outer strip and applying a compressing force upon the cover urging the cover and the two strips toward the mandrel, thereby creating the continuous laminated paint roller.

52. A method for continuously producing a composite cover material for use in the manufacture of paint rollers, the method comprising the steps of:
providing a width of porous applicator material having an applicator side and an underside;
advancing the width of applicator material with the underside facing up;
applying a backing layer comprising nucleated polypropylene on the underside of the advancing width of applicator material so that the layer has one side that is in contact with the underside of the advancing material and an other side that is not in contact with the advancing applicator material, the layer being in molten form when it is applied;
applying a compressive force to the other side of the layer before the layer hardens and sets to urge the backing layer and the underside of the applicator material together, thereby forming a composite material having a non-porous side and an applicator side; and
cutting the width of composite material into a strip once the backing layer is no longer in molten form, thereby forming a composite cover material having a non-porous side and an applicator pile side.

53. The method claimed in claim 52, wherein the applicator material is a pile material and the underside comprises a fabric backing, and wherein the pile is held fast on the composite material by the backing layer.

54. The method claimed in claim 52, wherein the applicator material is a natural skin, and the underside is the suede side of the natural skin.

55. The method claimed in claim 52, wherein the backing layer comprises a compound of nucleated polypropylene and between 5% and 66% calcium carbonate by weight.

56. The method claimed in claim 52, wherein the backing layer comprises a compound of nucleated polypropylene and approximately 12.5% calcium carbonate by weight, and wherein the compound has a melt flow index of approximately 70.

57. The method claimed in claim 52, wherein the backing layer comprises a compound of nucleated polypropylene and approximately 25% calcium carbonate by weight, and wherein the compound has a melt flow index of approximately 80.

58. A paint roller having a thermoplastic core and an absorptive cover, the core comprising:
an inner layer comprising nucleated polypropylene and calcium carbonate, wherein the inner layer comprises approximately 60% calcium carbonate by weight;
an interface layer comprising nucleated polypropylene and calcium carbonate, wherein the interface layer comprises approximately 45% calcium carbonate by weight; and
a cover binding layer comprising nucleated polypropylene and calcium carbonate, wherein the cover binding layer nor more than approximately 25% calcium carbonate by weight and no less than approximately 12.5% calcium carbonate by weight.

59. The paint roller claimed in claim 58 further comprising:
an additional layer adjacent to the interface layer, the additional layer comprising nucleated polypropylene and calcium carbonate, wherein the inner layer comprises approximately 60% calcium carbonate by weight; and
a second interface layer between the additional layer and the cover binding layer comprising nucleated polypropylene and calcium carbonate, wherein the second interface layer comprises approximately 45% calcium carbonate by weight.

60. The paint roller claimed in claim 58, wherein the first layer and the additional layer are between 10 mil and 25 mil in thickness, and wherein the interface layer and the second interface layer are between 10 mil and 20 mil in thickness.

61. The paint roller claimed in claim 58, wherein the first layer and the additional layer are approximately 10 mil in thickness, and wherein the interface layer and the second interface layer are approximately 10 mil in thickness.

62. The paint roller claimed in claim 58, wherein the inner layer is adjacent to the interface layer and the interface layer is adjacent to the cover binding layer.

63. The paint roller claimed in claim 62, wherein the first layer is between 10 mil and 25 mil in thickness, and wherein the interface layer is between 10 mil and 20 mil in thickness.

64. The paint roller claimed in claim 62, wherein the first layer is approximately 20 mil in thickness, and wherein the interface layer is approximately 20 mil in thickness.

65. A paint roller having a thermoplastic core and an absorptive cover, the core comprising:
an inner layer comprising a compound of nucleated polypropylene and calcium carbonate having an MFI of approximately 2;
an interface layer comprising a compound of nucleated polypropylene and calcium carbonate having an MFI of approximately 35; and
a cover binding layer comprising a compound of nucleated polypropylene and calcium carbonate having an MFI of approximately 80.
